(19) United States
(12) Patent Application Publication
(10) Pub. No.: US 2014/0252801 A1
(43) Pub. Date: Sep. 11, 2014

(54) METHOD FOR REBUILDING A MACHINE SURFACE

(71) Applicant: CATERPILLAR INC., Peoria, IL (US)

(72) Inventors: Daniel Raymond Hettinger, Monticello, IL (US); Steven W. Pangburn, Champaign, IL (US)

(73) Assignee: Caterpillar Inc., Peoria, IL (US)

(21) Appl. No.: 13/784,977

(22) Filed: Mar. 5, 2013

(51) Int. Cl. B62D 65/02; B60P 1/28

(52) U.S. Cl. CPC B62D 65/02; B60P 1/28
USPC 296/183.2; 29/402.08

(57) ABSTRACT

A method for rebuilding a truck body is provided. The method places a plurality of supports on a segment of a truck body. The plurality of supports defines at least a portion of the segment requiring rebuild. The method then places a rebuilding surface atop the plurality of supports. The rebuilding surface defines a void created between the rebuilding surface and the segment. The method also affixes the rebuilding surface atop the plurality of supports. The method further injects a layer of filler material into the void.

### TECHNICAL FIELD

The present disclosure relates to a method for rebuilding a machine surface, and more specifically for rebuilding a segment of a truck body.

### BACKGROUND

A truck body is used to transport material from one location to another. The truck body may be subjected to severe impacts during routine operational use. The impact may damage the truck body, causing wear and tear of the truck body like for example, erosion of a surface of the truck body, permanent deformation of sections of the truck body, etc. The damaged truck body may be rebuilt by installing a new plate over the existing damaged plate.

For example, U.S. Published Application Number 2012/0276364 provides a sandwich panel. The sandwich panel includes a first plate and a second plate spaced apart from the first plate. The sandwich panel also includes a core bonded to the first and the second metal plates so as to transfer shear forces between them. The core includes a main core material. The core also includes a lightweight material that is less dense than the main core material. The lightweight material is hydrophobic.

### SUMMARY OF THE DISCLOSURE

In one aspect of the present disclosure, a method is provided. The method places a plurality of supports on a segment of a truck body. The plurality of supports defines at least a portion of the segment requiring rebuild. The method then places a rebuilding surface atop the plurality of supports. The rebuilding surface defines a void created between the rebuilding surface and the segment. The method also affixes the rebuilding surface atop the plurality of supports. The method further injects a layer of filler material into the void.

In another aspect of the present disclosure, a truck body for a machine is provided. The truck body includes a segment. The truck body also includes a plurality of supports coupled to at least a portion of the segment. The truck body also includes a rebuilding surface attached atop the plurality of supports. The truck body further includes a layer of filler material provided between the rebuilding surface and the segment.

Other features and aspects of this disclosure will be apparent from the following description and the accompanying drawings.

### BRIEF DESCRIPTION OF THE DRAWINGS

FIG. 1 is an exemplary machine, according to one embodiment of the present disclosure;

FIG. 2 is a perspective view of a truck body having a plane 3-3 and a plurality of supports and spacers;

FIG. 3 is a sectional view of a portion of a rebuilt truck body along the plane 3-3; and

FIG. 4 is a method for rebuilding the truck body.

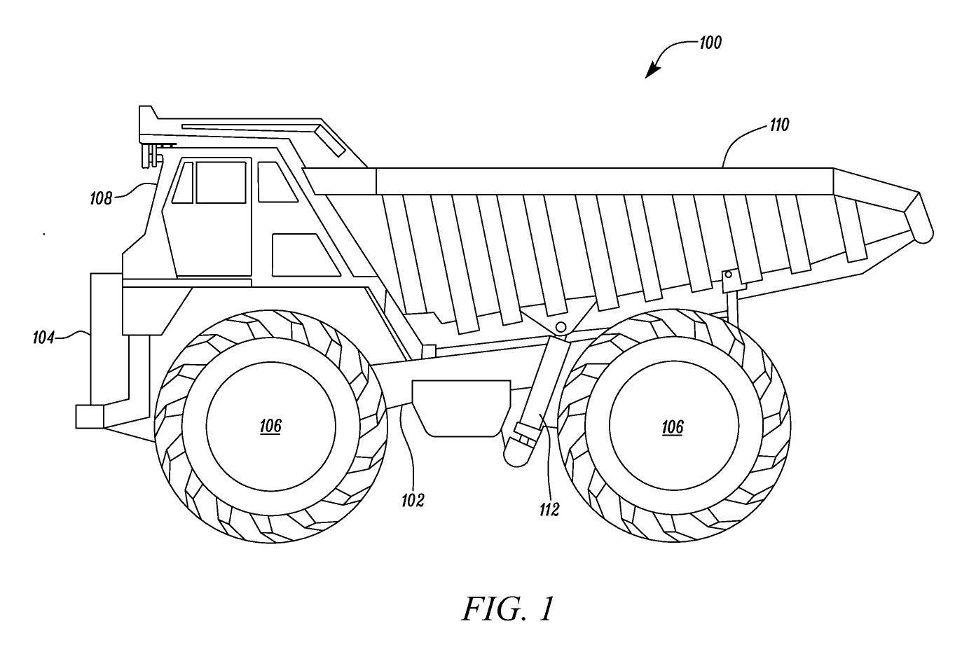

### DETAILED DESCRIPTION

Wherever possible, the same reference numbers will be used throughout the drawings to refer to the same or the like parts. FIG. 1 illustrates an exemplary machine 100, according to one embodiment of the present disclosure. More specifically, the machine 100 may be a large mining truck. It should be noted that the machine may also include a haul truck, an articulated truck, an off-highway truck or any other machine related to various industries like mining, forestry, waste management, construction, agriculture, etc.

Referring to FIG. 1, the machine 100 may include a frame and/or a chassis 102. A powertrain (not shown) may be provided on the machine 100 which may include one or more power sources. An enclosure 104 may be provided on the chassis 102 of the machine 100 which may house the power source (not shown). The power source may be any one or a combination of an internal combustion engine, a gas turbine, a hybrid engine, a non-conventional power source like batteries, electric motor, or any other power source known in the art. The powertrain may further include a transmission inclusive of gearing, drive shafts, propeller shaft and other known drive links provided for transmission of motive power from the power source to a set of ground engaging members 106. The ground engaging members 106, such as wheels, may be provided to the machine 100 for the purpose of mobility. An operator cabin 108 may be provided on the machine 100 which may house various controls of the machine 100.

As shown in FIG. 1, a truck body 110 may be fixedly or pivotally mounted on the chassis 102 of the machine 100. Hydraulic and/or pneumatic cylinders 112 may be mounted on the chassis 102 and connected to the truck body 110 to enable movement in the form of tilting of the truck body 110 with respect to the chassis 102 of the machine 100. The truck body 110 may be configured to receive, transport and dump payload from a source to a destination location. The payload may include construction material and/or other material such as, but not limited to, sand, gravel, stones, soil, excavated material, asphalt, coal, mineral ores, and the like. The truck body 110 may be appropriately constructed to perform an intended task of transportation of the payload.

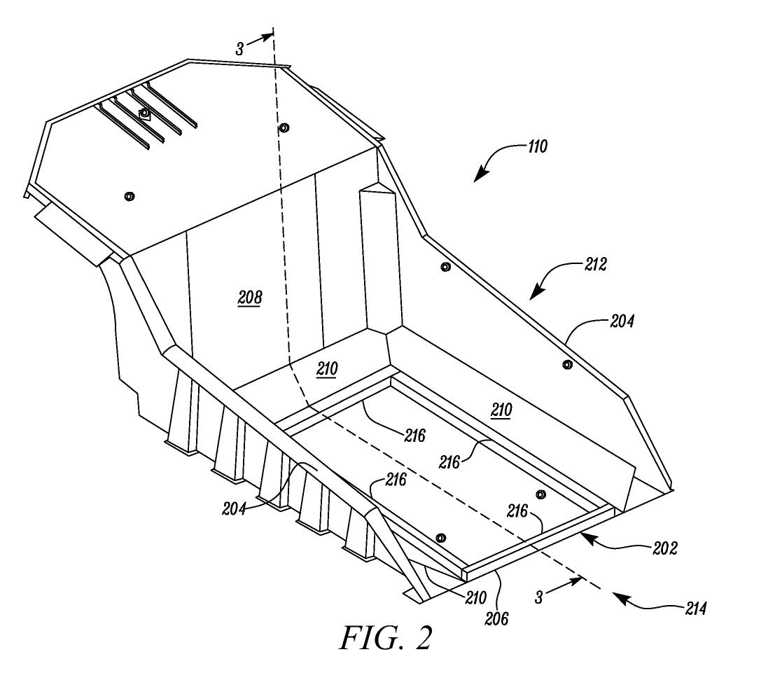

Referring to FIG. 2, a perspective view of the truck body 110 is shown. The truck body 110 may include a bed 202 having sidewall segments 204, a floor segment 206, a front wall segment 208 and transition segments 210. Each of the sidewall segments 204 and the front wall segment 208 may be connected to the floor segment 206. The transition segments 210 may be provided at the intersections of the sidewall segments 204, the floor segment 206 and the front wall segment 208. The transition segments 210 may create smooth transitions between the different segments of the truck body 110, thus, reducing sticking of the material and enabling easy flow of material from a material carrying cavity 212. Each of these segments may be of a desired size, dimension and shape, in order to form the material carrying cavity 212 based on the type of material carried. The material carrying cavity 212 may have a rear opening 214 through which the material may escape when the truck body 110 is tilted. In one embodiment, a rear gate (not shown in figure) or other device at the rear opening 214 may be used to contain the material in the truck body 110.

The segments of truck body 110 may experience severe impacts due to frequent loading and unloading of material. These impacts may cause damage to the truck body 110 in the form of erosion of the surface of the truck body 110, formation of cracks and/or deformation of the segments of the truck body 110 and the like. At times, the truck body 110 may require a repair for reinforcement and/or to increase its operable life by rebuilding any of the segments.

The present disclosure relates to a method for rebuilding the segments of the truck body 110. As shown in FIG. 2, a plurality of supports and spacers may be placed on the segment of the truck body 110 which requires rebuild. In the present disclosure, the segment requiring rebuild is the floor segment 206. It should be noted that the disclosure may also be utilized to fully or partially rebuild other segments of the truck body 110 like the front wall segment 208 and/or the side wall segments 204, without any limitation.

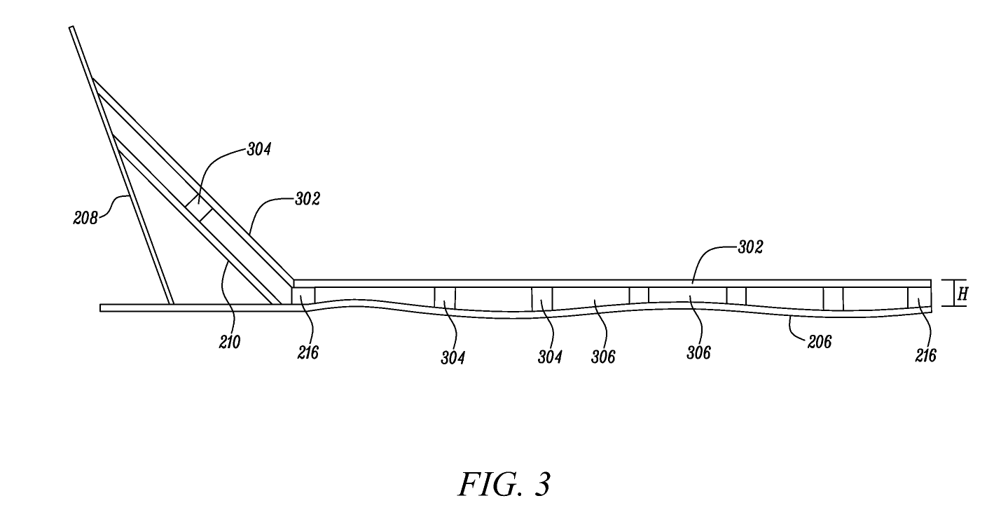

The plurality of supports may be configured in the form of bars 216, which are placed horizontally on the floor segment 206 around a portion of the floor segment 206 requiring rebuild. The plurality of bars 216 may be placed in a configuration such that the portion of the floor segment 206 requiring rebuild may be enclosed within the arrangement of the plurality of bars 216. The cross-section of the bars 216 may be of any cross-sectional configuration, such as rectangular, oval, round, I-shaped, T-shaped, C-shaped etc. Additionally, the bars 216 may be solid or hollow. Preferably, the bars 216 are made of a metal, such as, for example, steel or aluminum. Alternatively, other suitable materials like wood or engineering polymers may also be used. The height of the bars 216 may be such that a space is created between the floor segment 206 and a rebuilding surface 302 which is placed atop the bars 216, as shown in FIG. 3. The bars 216 may be firmly affixed to the floor segment 206 by any of the known methods of fastening including, but not limited to, welding, riveting, bolting, clamping and the like.

It should be understood that the bars 216 need to be affixed over the floor segment 206 in a fluid tight configuration. In one embodiment, suitable sealing material may be provided between a lower surface of each of the plurality of bars 216 and the floor segment 206, to provide the desired fluid tight fit. It should also be noted that a top surface of each of the plurality of bars 216 may be equally leveled to facilitate the placement of the rebuilding surface 302 atop the plurality of bars 216. FIG. 3 shows a cross-sectional view of the truck body 110 along the plane 3-3 shown in FIG. 2, after the rebuilding surface 302 is placed over the segment of the truck body 110 at a height “H”.

Referring to FIG. 3, a plurality of spacers 304 may be placed in a spaced apart arrangement on the floor segment 206. More specifically, the plurality of spacers 304 may be provided in the portion enclosed within the arrangement of plurality of bars 216. The plurality of spacers 304 may be fixedly attached to the floor segment 206 by any of the known methods of fastening including, but not limited to, welding, riveting, bolting, clamping, and the like. The plurality of spacers 304 may be made of any material including, but not limited to, wood, metals, rubber, polymers like polyurethane and polystyrene, etc. One of ordinary skill in the art will appreciate that when the plurality of spacers 304 are placed on the floor segment 206 having considerable deformations, the height of each of the plurality of spacers 304 may vary so as to reach the height “H”.

As shown in FIG. 3, the rebuilding surface 302 may be placed atop the arrangement of plurality of bars 216 and spacers 304. The rebuilding surface 302 is preferably made of steel. Any other suitable material may be used as per system requirements. The rebuilding surface 302 may have a flat sheet-like configuration. Parameters related to dimensions, thickness, material used, and the like may vary. The rebuilding surface 302 may be fixedly attached to a top surface of the plurality of bars 216 and/or spacers 304 by known methods, in order to create a fluid tight joint. For example, welding, riveting, bolting or any combination thereof may be utilized.

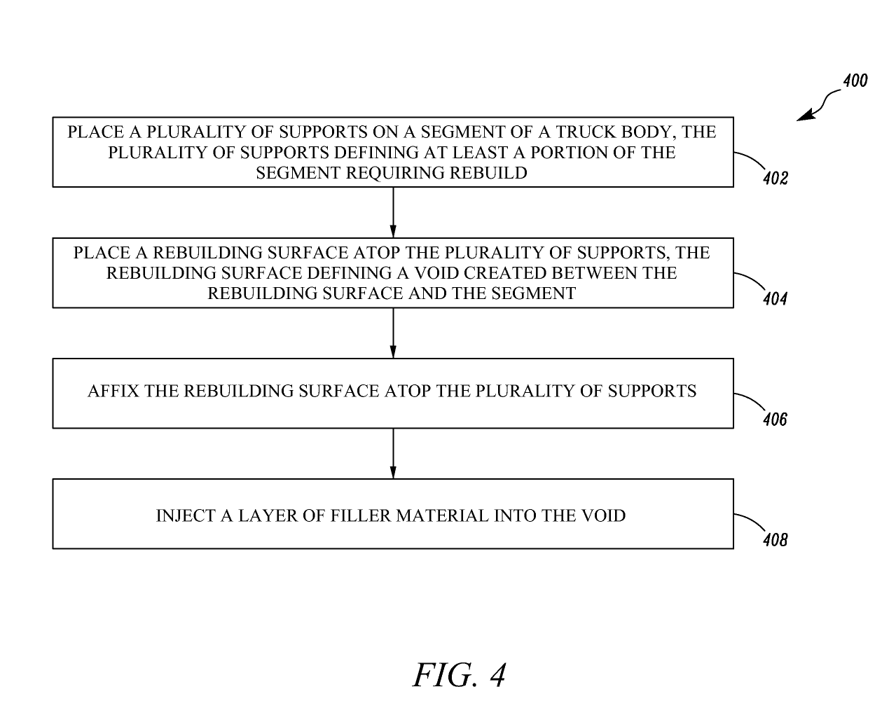

As shown in FIG. 3, a filler material 306 may be provided between the rebuilding surface 302 and the floor segment 206. The filler material 306 may be, preferably, polyurethane, however other polymers may also be suitable. The filler material 306 may be typically injected into a void existing between the rebuilding surface 302 and the floor segment 206 via an injection port (not shown). In one embodiment, any air present between the rebuilding surface 302 and the floor segment 206 may be vented out through a ventilation port (not shown). Initially, the filler material 306 may be in a liquid state when introduced into the space between the rebuilding surface 302 and the floor segment 206. The filler material 306 may be allowed to solidify to create an integral composite including the original floor segment 206, the rebuilding surface 302, and the filler material. A method 400 for rebuilding the segment of the truck body 110 will be described in detail in connection with FIG. 4.

One of ordinary skill in the art will appreciate that the in the illustrated embodiment, the rebuilding surface 302 is provided on the floor segment 206 to level out the deformations present on the floor segment 206 and to provide a new wear surface. As can be seen, the rebuilding surface 302 may also be provided on the transition segment 210 which lies adjacent to the floor segment 206. This may facilitate in maintaining the overall geometry of the truck body 110 in order to allow the payload to easily flow out of the material carrying cavity 212 or to provide a new, generally flat wear surface.

### INDUSTRIAL APPLICABILITY

A truck body may require rebuilding due to distortions or deformations created on its material carrying surface. The present disclosure relates to the method of rebuilding the segment of the truck body. Initially, a segment of the truck body 110 requiring rebuild may undergo a cleaning process to remove unwanted dirt, debris, depositions, etc., if any. The cleaning process may be either a manual or an automated scraping of the surface of the truck body 110 by use of appropriate tools and/or solvents. Further, the cleaned truck body 110 may be grit blasted to remove additional depositions like rust, paint, etc., which may not have been cleaned appropriately during the cleaning process and to provide a sufficiently rough surface to facilitate adhesion of filler material 306.

Referring to FIG. 4, at step 402, the plurality of supports may be placed horizontally on the segment of the truck body 110 on an area requiring rebuild. The plurality of supports may be configured in the form of bars 216. The plurality of bars 216 may be firmly affixed to the segment of the truck body 110 by any known method of fastening like welding. Additionally, spacers 304 may be placed on the segment of the truck body 110 enclosed within the arrangement of the plurality of bars 216.

At step 404, the rebuilding surface 302 may be placed atop the arrangement of the plurality of bars 216 and the spacers 304. At step 406, the rebuilding surface 302 may be firmly affixed to the bars 216 by any known method of fastening like welding, bolting, riveting or the like. The placing of the rebuilding surface 302 over the arrangement of the bars 216 and the spacers 304 may create a void between the rebuilding surface 302 and the floor segment 206.

At step 408, the filler material 306 may be injected into the void through the injection port. In one embodiment, when the filler material 306 has a relatively low viscosity, the filler material 306 may be allowed to flow freely into the void. In another embodiment, when the filler material 306 has a relatively high viscosity, a pump may be used to push the filler material 306 into the void.

Further, air trapped between the rebuilding surface 302 and the floor segment 206 of the truck body 110 may be allowed to vent out to the atmosphere during injection of the filler material 306 through the ventilation port. Alternatively, a vacuum device like a vacuum pump may be used to force the trapped air out. The filler material 306 may then be allowed to solidify. Solidification may cause the filler material 306 to become rigid providing firm support to the rebuilding surface 302 placed over the floor segment 206. Further, solidification of the filler material 306 may result in the filler material 306 bonding to the floor segment 206 and to the rebuilding surface 302, resulting in an integral composite including the original floor segment 206, the rebuilding surface 302, and the filler material 306.

In one embodiment, after the rebuilding surface 302 is fixedly attached to the plurality of bars 216, additional pressure may be applied atop the rebuilding surface 302 before injection of a filler material 306 in the void. The additional pressure may be applied by placing appropriate weights atop the rebuilding surface 302 and/or by the use of a mechanical press and/or by other structural elements that are restrained by temporary welds, magnets, or other temporary fastening methods. The additional pressure may be applied till the filler material 306 is cured. The additional pressure may prevent structural distortion of the rebuilding surface 302 during the injection and curing of the filler material 306. Finally, the injection ports and the ventilation ports may be sealed off to complete the rebuilding of the segment of the truck body 110.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for rebuilding a truck body, the method comprising:
placing a plurality of supports on a segment of the truck body, the plurality of supports defining at least a portion of the segment requiring rebuild;
placing a rebuilding surface atop the plurality of supports, the rebuilding surface defining a void created between the rebuilding surface and the segment;
affixing the rebuilding surface atop the plurality of supports; and
injecting a layer of filler material into the void.

2. The method of claim 1 further comprising providing a plurality of spacers within the defined portion, wherein the plurality of spacers are in contact with the segment of the truck body.

3. The method of claim 1 wherein the step of placing a plurality of supports comprises placing a plurality of bars oriented horizontally on the truck body.

4. The method of claim 1, wherein the affixing includes at least one of welding, riveting, and bolting.

5. The method of claim 1, wherein the filler material is injected in the void through an injection port.

6. The method of claim 1 further comprising removing trapped air from the void after injection of the filler material through a ventilation port.

7. The method of claim 1 further comprising applying an increased pressure on the rebuilding surface prior to the injection of the filler material.

8. The method of claim 1 further comprising curing the injected filler material at a pre-determined temperature.

9. The method of claim 1, wherein the filler material includes polyurethane.

10. The method of claim 1, wherein the segment includes at least one of a floor segment, a front segment, and a side segment of the truck body.

11. A truck body for a machine, the truck body comprising:
a segment;
a plurality of supports coupled to at least a portion of the segment;
a rebuilding surface attached atop the plurality of supports; and
a layer of filler material provided between the rebuilding surface and the segment.

12. The truck body of claim 11 wherein the plurality of supports comprises a plurality of bars oriented horizontally on the truck body.

13. The truck body of claim 11, wherein the rebuilding surface is made of steel.

14. The truck body of claim 11, wherein the filler material includes polyurethane.

15. The truck body of claim 11, wherein the segment includes at least one of a floor segment, a front segment, and a side segment of the truck body.

16. The truck body of claim 11 further comprising a plurality of spacers provided within the portion of the segment, wherein the plurality of spacers are in contact with the segment of the truck body.

17. A machine comprising:
a power source;
a frame; and
a truck body coupled to the frame of the machine, the truck body comprising:
a segment;
a plurality of supports coupled to at least a portion of the segment;
a rebuilding surface attached atop the plurality of supports; and
a layer of filler material provided between the rebuilding surface and the segment.

18. The machine of claim 17 wherein the plurality of supports comprises a plurality of bars oriented horizontally on the truck body.

19. The machine of claim 17 wherein the rebuilding surface is made of steel.

20. The machine of claim 17 wherein the filler material includes polyurethane.
